(19) United States
(12) Patent Application Publication
(10) Pub. No.: US 2006/0108970 A1
(43) Pub. Date: May 25, 2006

(54) Integrated fuel cell system

(76) Inventors: Jeremy D. Leasure, Jackson, TN (US); Mark A. Etter, Humboldt, TN (US); Robert F. Burkholder, Rotonda West, FL (US); Kathy DeKeyser, Jackson, TN (US)

Correspondence Address: THE BLACK & DECKER CORPORATION, 701 EAST JOPPA ROAD, TW199, TOWSON, MD, 21286, US

(21) Appl. No.: 11/109,493

(22) Filed: Apr. 19, 2005

Related U.S. Application Data
(63) Continuation-in-part of application No. 10/868,344, filed on Jun. 14, 2004.
(60) Provisional application No. 60/477,906, filed on Jun. 11, 2003.

(51) Int. Cl. H02J 7/35; H01M 8/00

(52) U.S. Cl. 320/101; 429/13

(57) ABSTRACT

A battery charger includes a carrying case housing, a docking station at least partially contained by the housing, and a fuel cell system at least partially contained by and electrically coupled with the docking station. The carrying case housing is configured for transporting a cordless tool and includes a handle member for transporting the housing. The docking station is configured for physically and electrically coupling a removable battery. The fuel cell system produces and provides electrical energy for charging a removable battery coupled with the docking station.

### CROSS-REFERENCE TO RELATED APPLICATIONS

The present application is a continuation-in-part (CIP) application and claims priority under 35 U.S.C. § 120 to U.S. patent application Ser. No. 10/868,344 entitled: Integrated Fuel Cell System filed Jun. 14, 2004, which in turn claims priority under 35 U.S.C. § 119(e) to U.S. Provisional Application No. 60/477,906 entitled: Fuel Cell Assembly filed Jun. 11, 2003, both of which are hereby incorporated by reference in their entirety.

### FIELD OF THE INVENTION

The present invention generally relates to the field of fuel cells and particularly, to a family of power tools implementing a common fuel cell system for standardizing the power requirements for the tools within the family. The fuel cell system is integrated with the family of power tools for providing power to those tools. In addition, individual power tools within the family may be semi-customized to accommodate the fuel cell system.

### BACKGROUND OF THE INVENTION

Carpenters regularly utilize certain power tools when working at a jobsite. For example, a power tool such as a portable generator may be utilized for providing power to other tools, such as saws and drills, when a standard electrical power source outlet is not available. Also, a portable compressor may be utilized for providing power to a pneumatic fastener, such as a nailer. Portable generators typically are run by gas-powered engines. The problem with such generators is that they are often noisy and also emit fumes associated with gas combustion, thus making them impractical to use in areas where ventilation is poor. Portable compressors typically are run by a motor, thus requiring access to a standard electrical power source outlet. When an outlet is not nearby, a carpenter utilizing such a compressor may be forced to utilize one or more extension cords to connect the compressor to a remotely located outlet. As a result, extension cords clutter the work area and can be in the way of those trying to move about the jobsite.

Therefore, it would be advantageous to have a family of power tools, such as portable generators or portable compressors, which could be powered by a common power system for maximum increase in flexibility and convenience.

### SUMMARY OF THE INVENTION

Accordingly, a first aspect of the present invention is directed to a system wherein each member of a family of power tools individually includes a common fuel cell system for providing power to each tool within the family.

A second aspect of the present invention is directed to a battery charger including a fuel cell system in accordance with an exemplary embodiment of the present invention. The battery charger is configured for charging removable batteries for power tools.

A third aspect of the present invention is directed to a workstation including a fuel cell system in accordance with an exemplary embodiment of the present invention. The workstation further includes one or more work lights, for illuminating a workspace and a battery charger docking station, for charging removable batteries for power tools.

A fourth aspect of the present invention is directed to a portable compressor including a fuel cell system in accordance with an exemplary embodiment of the present invention. The portable compressor is configured for powering tools.

A fifth aspect of the present invention is directed to a portable generator including a fuel cell system in accordance with an exemplary embodiment of the present invention. The portable generator is configured for powering corded devices.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1A is an isometric view of a fuel cell-powered battery charger having, as a housing, a carrying case for a cordless power tool in accordance with an exemplary embodiment of the present invention, the carrying case being shown in a closed position;

FIG. 1B is a perspective view of the fuel cell-powered battery charger having, as a housing, a carrying case for a cordless power tool in accordance with an exemplary embodiment of the present invention, the carrying case being shown in an open or unlocked position;

FIG. 2A is an isometric view of a fuel cell-powered workstation in accordance with an exemplary embodiment of the present invention;

FIG. 2B is an isometric view of an opposing side of the fuel cell-powered workstation shown in FIG. 2A, the view further illustrating the varied positioning of the work lights in relation to FIG. 2A via the utilization of turning knobs in accordance with an exemplary embodiment of the present invention;

FIG. 3A is an isometric view of a portable compressor including a fuel cell system in accordance with an exemplary embodiment of the present invention;

FIG. 3B is an isometric cutaway view of the portable compressor shown in FIG. 3A, the portable compressor including a fuel cell system in accordance with an exemplary embodiment of the present invention; and

FIG. 4 is a partial exploded view of a portable generator including a fuel cell system having a plurality of stackable fuel cell units included therein in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

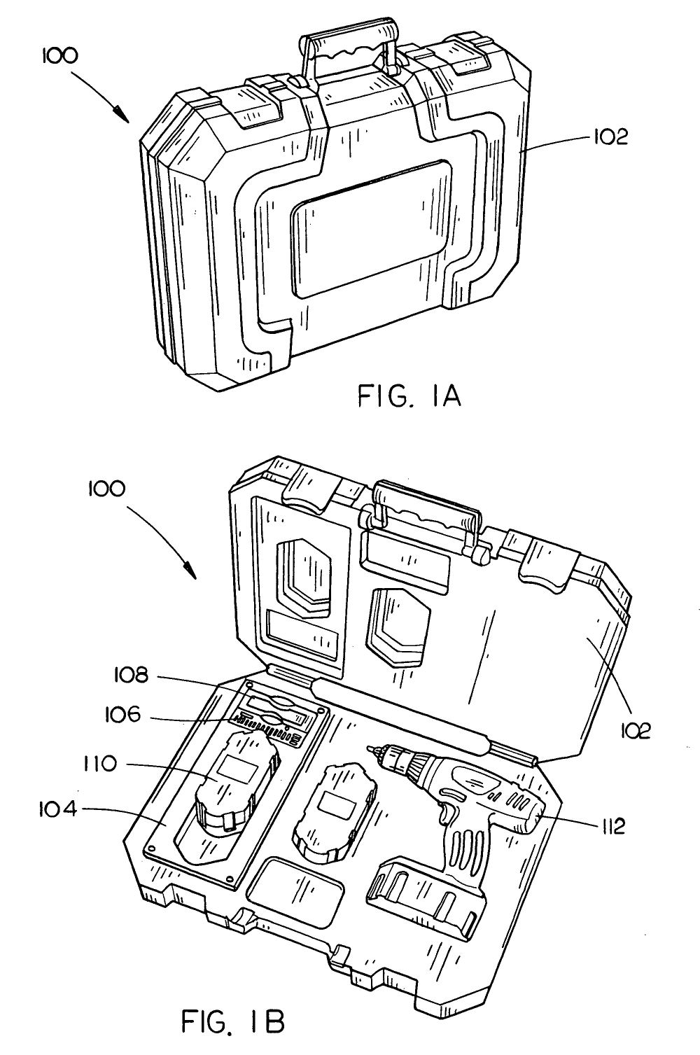

Referring generally to FIGS. 1A through 4, exemplary embodiments of the present invention are shown. Accordingly, a first aspect of the present invention is directed to a system wherein each member of a family of power tools individually includes a common fuel cell system for providing power to each tool within the family. For example, the family of tools includes a battery charger, a workstation, a portable compressor, a portable generator and the like, all powered by a common fuel cell system. The fuel cell system includes a fuel cell unit and a uniform fuel cartridge. Each tool within the family is configured with at least one fuel cell unit. The fuel cell unit is configured with a port for removably receiving a uniform fuel cartridge. The fuel cell unit, for example, a hydrogen/oxygen (PEM) fuel cell unit, may be a plurality of fuel cells grouped together as a unit. The uniform fuel cartridge, for example, a methanol fuel cartridge, is physically coupled with the fuel cell unit via the port. The uniform fuel cartridge is removably coupled with the fuel cell unit in a manner which allows for the transfer of fuel, such as pressurized hydrogen, from the cartridge to the fuel cell unit, thereby allowing the fuel cell unit to provide electrical power to the tools.

The uniform fuel cartridge is configured for interchangeable use among the tools within the family. In additional embodiments, the fuel cell system allows for tools within the family to be configured with multiple fuel cell units based on power demand. In an exemplary embodiment, a tool within the family, such as a portable generator, includes a plurality of stackable fuel cell units. Each stackable fuel cell unit is configured for removably receiving one or more uniform fuel cartridges. Multiple stackable fuel cell units may be utilized as necessary based on power demand. The present invention therefore provides a unified system of providing power to a family of power tools and also, provides a scheme for allowing the family of tools to provide power to tools of various voltages.

Referring to FIGS. 1A and 1B, a fuel cell-powered battery charger in accordance with an embodiment of the present invention is discussed. The fuel cell-powered battery charger 100 includes a housing 102. In a present embodiment, the housing 102 is a carrying case for transporting a cordless tool 112, the carrying case including a handle member for transporting the carrying case. In a further embodiment, the housing 102 is a stand-alone unit, such as a stand-alone molded plastic housing. In the illustrated embodiment, the carrying case housing 102 is a clamshell configuration including an upper portion hingedly connected with a lower portion for establishing the housing 102 in open and closed positions.

The battery charger 100 further includes a docking station 104, which is at least partially contained by the housing 102. The docking station 104 is configured with one or more corresponding physical connectors for physically coupling a removable battery 110, such as for utilization with a family of cordless tool batteries employing common physical connections. For example, the docking station 104 may be configured with rails for slidably coupling a removable battery 110. The docking station 104 is further configured with one or more corresponding terminals for electrically coupling a removable battery 110, such as for utilization with a family of cordless tool batteries employing common electrical schemes. For instance, the docking station 104 may be configured with electrical contacts, such as blades, posts and the like for electrically coupling a removable battery 110.

The battery charger 100 further includes a fuel cell system. The fuel cell system includes at least one fuel cell unit 106, such as a hydrogen/oxygen (PEM) fuel cell unit, and at least one corresponding uniform fuel cartridge 108, such as a methanol fuel cartridge. In a present embodiment, the fuel cell unit 106 is at least partially contained by the docking station 104. The fuel cell unit 106 is also configured with a port for removably receiving and coupling with, such as by a post connection, the uniform fuel cartridge 108. In an exemplary embodiment, the port of the fuel cell unit 106 is configured to fully accept the cartridge 108. In additional embodiments, the port is configured to partially accept the cartridge 108. Embodiments in which the cartridge 108 is fully accepted provide the advantages of reducing the profile of the battery charger 100 and better protecting the cartridge 108. In a preferred embodiment, the cartridge 108 is generally rectangular-shaped and is notched or tapered to accommodate manual removal of the cartridge 108 from the port.

The cartridge 108, upon introduction via the port, is physically coupled with the fuel cell unit 106 in such a manner as to allow for the transport of fuel, such as pressurized hydrogen, from the fuel cartridge 108 to the fuel cell unit 106. Upon disconnection of the cartridge 108 from the fuel cell unit 106, the fuel cartridge 108 is configured to prevent the flow of fuel from the cartridge 108. In an exemplary embodiment, the cartridge 108 includes one or more connectors, such as spring-loaded valves, and the fuel cell unit 106 is configured with one or more corresponding receptors, which removably receive and couple with the spring-loaded valves of the cartridge 108. Upon insertion of the cartridge 108 into the port, the spring-loaded valves of the cartridge 108 are received by the receptors of the fuel cell unit 106, which allows for the transport of fuel from the cartridge 108 to the fuel cell unit 106. The fuel cell unit 106 converts hydrogen and oxygen received from the uniform fuel cartridge 108 into water, thereby producing electrical energy. Further, the fuel cell unit 106, being electrically coupled with circuitry of the battery charger 100, provides this electrical energy via the circuitry for charging a battery 110 coupled with the docking station 104 of the battery charger 100. Upon disconnection from the receptors, the spring-loaded valves are further configured to prevent the flow of fuel from the cartridge 108. In a preferred embodiment, the cartridge 108 is disposable. In an alternative embodiment, the cartridge 108 may be refueled.

In additional embodiments, the port includes a mechanism for ejecting the uniform fuel cartridge 108. In one embodiment, the ejection mechanism is a push-button mechanism that activates levers configured within the port. The levers proceed to push against the cartridge 108, thereby disconnecting the connectors of the cartridge 108 from the receptors of the fuel cell unit 106 and ejecting the cartridge 108 from the port. In other embodiments, the ejection mechanism is a spring-loaded mechanism and the like.

In a preferred embodiment, the fuel cell system is configured so that a single uniform fuel cartridge 108 and fuel cell unit 106 allow the battery charger 100 to recharge a battery 110 within the run-down time of a tool utilizing a substantially similar battery. For example, if the rundown time for a 19.2-volt battery for a cordless drill is 2 hours, the fuel cell system preferably is configured so that the battery charger 100 is able to recharge the battery in less than 2 hours. This way, a user of the cordless drill 112 can continue working using a spare battery while a first battery is recharging and the first battery will be recharged and ready for use before the spare battery runs down. Those of skill in the art will appreciate that run-down time may include time during which a tool is not operating, such as time between drilling operations and the like. In additional embodiments, the fuel cell system is configured so that a single uniform fuel cartridge 108 is able to recharge a battery multiple times before the cartridge has to be replaced or refueled.

In a further embodiment, the battery charger 100 includes one or more indicators which provide information to a user regarding the various components of the battery charger. For example, a visual (i.e.—blinking light, LED graphical indicator) or an audible indicator provides an indication as to when a battery 110 has begun and/or commenced charging, when a uniform fuel cartridge 108 needs replaced and the like.

In additional embodiments, the battery charger 100 includes a device for connection to a standard electrical power source outlet. In further embodiments, a battery charger 100 configured to accept a standard electrical power source connection also includes a power conditioner, such as a signal/line conditioner, a double line conversion conditioner and the like. The power conditioner assists in providing an uninterrupted flow of electricity from the standard electrical power source to the battery charger 100.

In further embodiments, the housing 102 includes a plurality of recesses contoured for receiving/storing items such as a power tool 112, a uniform fuel cartridge 108, a removable battery 110 not undergoing recharging, a power cord and the like. In the illustrated embodiment, the housing 102 is contoured with a plurality of recesses disposed within its upper portion for allowing clearance for the housing 102 to be established in a closed position while a removable battery 110 is being charged. In additional embodiments, the housing 102 may include one or more vents for dissipating heat from within the housing 102.

In exemplary embodiments, the electronics of the battery charger 100 are configured, upon connection of the battery charger 100 to a standard power source outlet, to automatically operate the battery charger 100 exclusively from the standard power source rather than the fuel cell system. This feature conserves fuel cell system resources and also allows for refueling or replacement of the cartridge 108. In embodiments in which the battery charger 100 is being operated from a standard power source, the electronics of the battery charger 100 are able to detect the presence of a coupled battery 110 and allocate an appropriate amount of current from the standard power source to the docking station 104 for charging the coupled battery. In an exemplary embodiment, upon fully charging the coupled battery 110, the battery charger 100 may provide a trickle charge for keeping the battery 110 fully charged and conserving electricity.

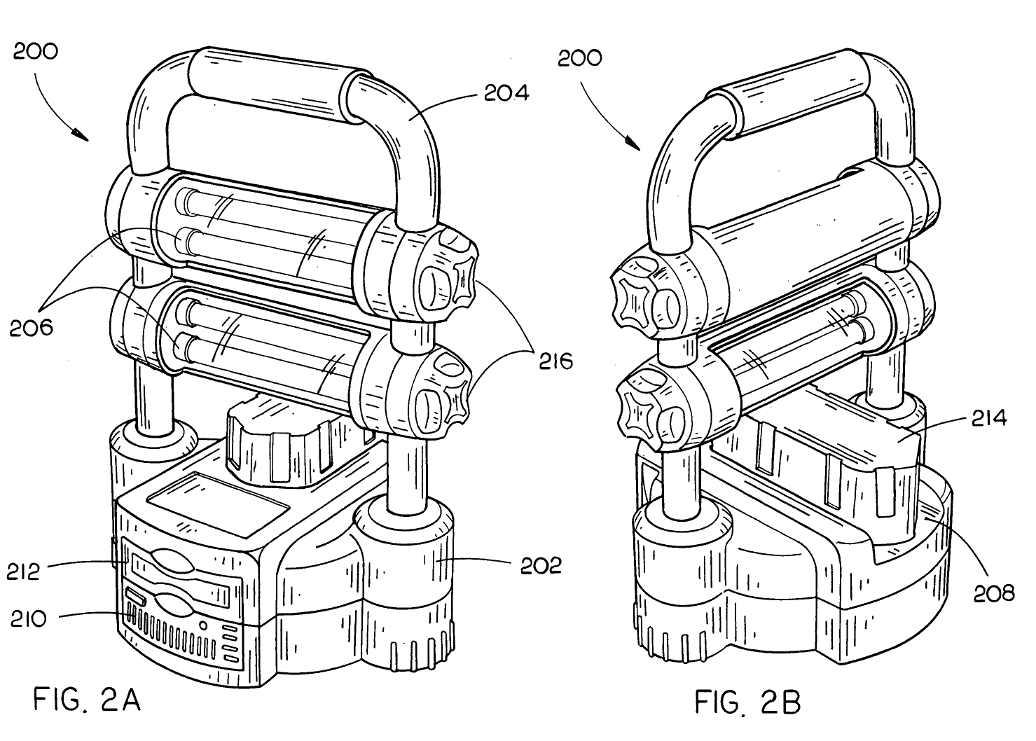

Referring to FIGS. 2A and 2B, a fuel cell-powered workstation in accordance with an exemplary embodiment of the present invention is discussed. The fuel cell-powered workstation 200 includes a supporting base 202 and a handle member 204 for transporting the workstation. In the illustrated embodiment, the handle member 204 is a U-shaped handle member which is coupled to the supporting base 202. It is contemplated that the handle member 204 may be various configurations.

The workstation 200 also includes one or more work lights 206 for illuminating a workspace where the workstation 200 may be employed. In an exemplary embodiment, each work light 206 includes a plurality of fluorescent bulbs contained within an enclosure. The work lights 206 are removably and rotatably attached to the handle member 204. The handle member 204 is configured with a plurality of corresponding turning knobs 216, the knobs 216 being mechanically and rotatably coupled to the work lights 206, thereby allowing a user to manually rotate the work lights 206.

The workstation 200 further includes a docking station 208, which is at least partially contained by and disposed within an upper surface of the supporting base 202. The docking station 208 is configured with one or more corresponding physical connectors, such as generally opposed rails, and one or more corresponding electrical contacts for physically and electrically coupling a removable battery 214, such as for utilization with a family of cordless tool batteries employing common physical connections and electrical schemes. Further, the workstation 200 includes circuitry for directing electricity to the work lights 206 and the docking station 208.

The workstation 200 further includes a fuel cell system, the fuel cell system having at least one fuel cell unit 210 and at least one corresponding uniform fuel cartridge 212. The fuel cell unit 210 is at least partially contained within the supporting base 202 and is electrically coupled with the circuitry of the workstation 200 in such a manner that the fuel cell unit 210 may charge a removable battery 214 and illuminate the worklights 206. The fuel cell unit 210 is configured with a port for removably receiving the uniform fuel cartridge 212. The uniform fuel cartridge 212 is removably coupled to the fuel cell unit 210 via the port. In an embodiment, the cartridge 212 is fully accepted by the port. In a further embodiment, the cartridge 212 is partially accepted by the port. In additional embodiments, the port includes an ejection mechanism for ejecting the uniform fuel cartridge 212.

The cartridge 212, upon introduction via the port, is physically coupled with the fuel cell unit 210 in such a manner as to allow for the transport of fuel from the cartridge 212 to the fuel cell unit 210. Upon disconnection of the cartridge 212 from the fuel cell unit 210, the fuel cartridge 212 is configured to prevent the flow of fuel from the cartridge 212. The fuel cell unit 210 converts hydrogen and oxygen received from the uniform fuel cartridge 212 into water, thereby producing electrical energy for charging a battery 214 coupled with the docking station 208 of the battery charger 200 and for illuminating the worklights 206. The workstation 200 may also include a power (ON/OFF) switch for the worklights 206.

In a preferred embodiment, the fuel cell system is configured so that a single uniform fuel cartridge 212 and fuel cell unit 210 are able to provide power to both the work lights 206 and the battery charger docking station 208 of the workstation 200. Preferably, the fuel cell system is configured to recharge a battery 214 within the run-down time for a tool utilizing a substantially similar battery, while also providing power for illuminating the work lights. In further embodiments, the fuel cell system is also configured so that a single uniform fuel cartridge 212 is able to recharge a battery 214 multiple times before the cartridge has to be replaced or refueled.

In a further embodiment, the workstation 200 includes one or more indicators for providing information to a user regarding the various components of the workstation such as the status of a fuel cartridge 212 or a charging battery 214. In additional embodiments, the workstation 200 includes a device for connection to a standard electrical power source outlet. In embodiments where a workstation 200 is configured to accept a standard electrical power source connection, the workstation may also include a power conditioner for providing an uninterrupted flow of electricity to the workstation 200.

In current embodiments, electronics of the workstation 200 are configured, upon connection of the workstation to a standard power source outlet, to automatically operate the workstation exclusively or partially from the standard power source, thereby conserving fuel cell system resources. In embodiments in which the workstation 200 is being operated from a standard power source, the electronics of the workstation 200 are able to detect the presence of a coupled battery 214 and allocate an appropriate amount of current from the standard power source to the docking station 208 for charging the coupled battery. In an exemplary embodiment, upon fully charging the coupled battery 214, the workstation 200 may provide a trickle charge for keeping the battery 214 fully charged and conserving electricity.

In further embodiments, the worklights 206 are configured to run off of a removable battery 214 coupled with the docking station 208 when the fuel cell system is not producing electrical energy.

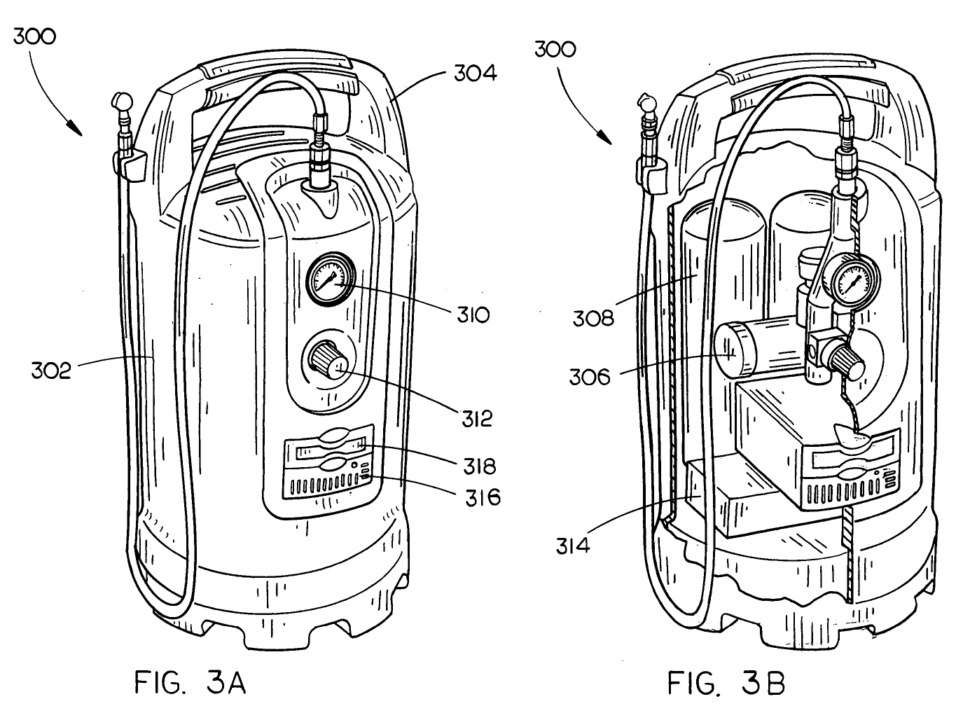

Referring to FIGS. 3A and 3B, a portable compressor including a fuel cell system in accordance with an exemplary embodiment of the present invention is discussed. The portable compressor 300 includes a housing 302. The housing 302 at least partially contains a motor and manifold 306 and one or more storage tanks 308 for storing compressed air. The compressor 300 further includes a pressure gauge 310 and pressure regulator 312, both disposed on the exterior surface of the housing 302. The compressor 300 also includes a carrying handle 304, which is coupled with the housing 302 for transporting the compressor 300.

The compressor 300 further includes a fuel cell system, the fuel cell system having at least one fuel cell unit 316 and at least one corresponding uniform fuel cartridge 318. The fuel cell unit 316 is at least partially contained within the housing 302. In an exemplary embodiment, the fuel cell unit 316 is electrically coupled via circuitry of the compressor 300 with at least one internal battery, which is at least partially contained by the housing of the compressor 300. The internal battery stores electrical energy provided by the fuel cell system. The internal battery is electrically coupled with the motor 306 of the compressor 300 and provides the stored energy to the motor 306, thereby allowing the motor 306 to meet peak power demands of the compressor 300. The internal battery is configured for a family of tools employing a common voltage scheme, such as for power tools. The fuel cell unit 316 is configured with a port for removably receiving the uniform fuel cartridge 318. The uniform fuel cartridge 318 is removably coupled with the fuel cell unit 316 via the port. In an embodiment, the cartridge 318 is fully accepted by the port. In a further embodiment, the cartridge 318 is partially accepted by the port. The cartridge 318, upon introduction via the port, is physically coupled with the fuel cell unit 316 in such a manner as to allow for the transport of fuel from the cartridge 318 to the fuel cell unit 316. Upon disconnection of the cartridge 318 from the fuel cell unit 316, the fuel cartridge 318 is configured to prevent the flow of fuel from the cartridge 318. The fuel cell unit 316 converts hydrogen and oxygen received from the uniform fuel cartridge 318 into water, thereby producing electrical energy for charging the internal battery, thereby allowing the internal battery to power the compressor 300. In additional embodiments, the port includes an ejection mechanism for ejecting the uniform fuel cartridge 318.

Preferably, the fuel cell system of the present invention is configured so that a single uniform fuel cartridge 318 and fuel cell unit 316 provide enough electrical energy to the internal battery to allow the compressor 300 to power low demand tools, such as a nailer. When powering multiple or higher demand tools or appliances, further embodiments of the compressor 300 may be configured with various combinations of multiple fuel cell units 316 and multiple internal batteries to meet peak power demands.

In additional embodiments, the compressor 300 includes a device for connection to a standard electrical power source outlet. In further embodiments, a compressor 300 configured to accept a standard electrical power source connection also includes a conditioner for providing an uninterrupted flow of electricity to the compressor 300.

In further embodiments, electronics contained within the compressor 300 are configured, upon connection of the compressor to a standard power source outlet, to automatically operate the compressor exclusively or partially from the standard power source to conserve battery resources. In alternative embodiments, the compressor 300 includes one or more indicators, which provide information to a user regarding the various components of the compressor. In additional embodiments the compressor 300 includes one or more inverters 314, if for example the portable compressor includes an AC motor.

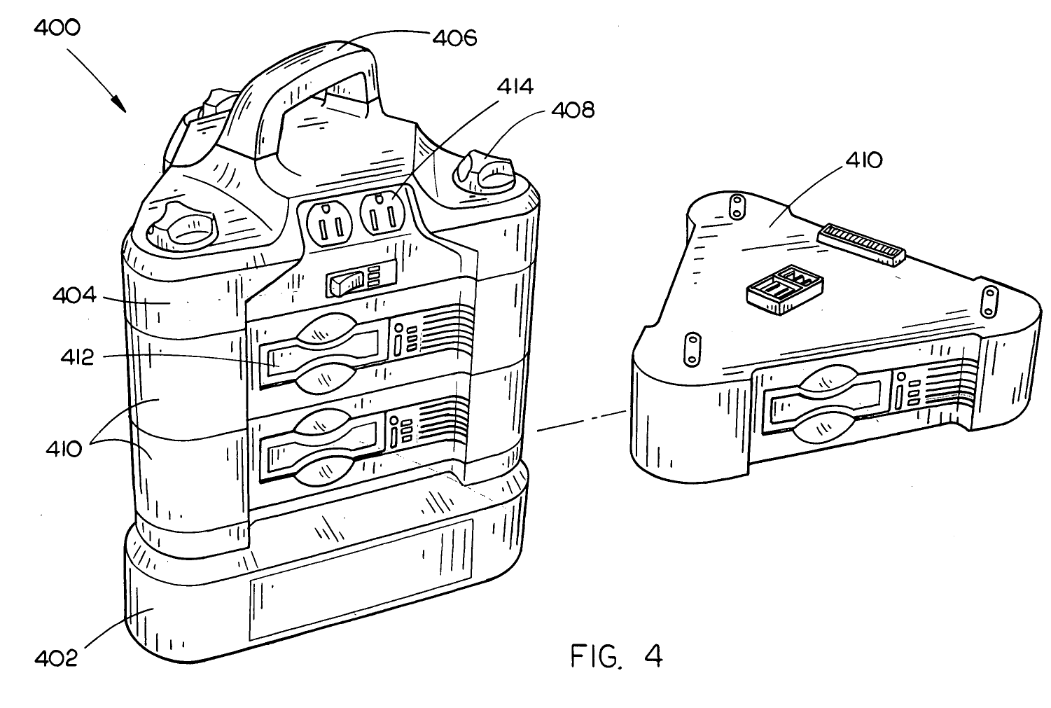

Referring to FIG. 4, a portable generator including a fuel cell system in accordance with an exemplary embodiment of the present invention is discussed. The portable generator 400 includes a supporting base 402 and a housing 404. The housing 404 includes one or more outlets 414 for electrically coupling with corded devices, such as corded power tools. The generator 400 also includes a carrying handle 406, coupled with the housing 404, for transporting the generator.

The generator 400 further includes a fuel cell system, the fuel cell system having at least one stackable fuel cell unit 410 and at least one corresponding uniform fuel cartridge 412. The stackable fuel cell unit 410 is removably configured between the housing 404 and the supporting base 402. In an exemplary embodiment, locking knobs 408, configured with the housing 404, are manually adjusted to manipulate a locking mechanism, which secures the stackable fuel cell unit 410 between the housing 404 and the supporting base 402. For example, the locking mechanism may be a series of slide locks, through rods, quick coupling locks, twist locks, bayonet locks, and the like. Further, the stackable fuel cell system is electrically coupled with circuitry of the generator 400 for providing electrical power for the generator 400. In further embodiments, the stackable fuel cell unit 410 is electrically coupled with at least one internal battery, which is at least partially contained by the supporting base 402 or housing 404 of the generator 400. The internal battery stores electrical energy provided by the stackable fuel cell unit 410 and may use its stored electrical energy to provide power for the generator 400. The internal battery is configured for a family of tools employing a common voltage scheme, such as for power tools. The stackable fuel cell unit 410 is configured with one or more ports for removably receiving a uniform fuel cartridge 412. The uniform fuel cartridge 412 is removably coupled with the stackable fuel cell unit 410 via the port. In an embodiment, the cartridge 412 is fully accepted by the port. In a further embodiment, the cartridge 412 is partially accepted by the port. The cartridge 412, upon introduction via the port, is physically coupled with the stackable fuel cell unit 410 in such a manner as to allow for the transport of fuel from the cartridge 412 to the fuel cell unit 410. Upon disconnection of the cartridge 412 from the fuel cell unit 410, the fuel cartridge 412 is configured to prevent the flow of fuel from the cartridge 412. In additional embodiments, the port includes a mechanism for ejecting the uniform fuel cartridge 412.

Preferably, the fuel cell system is configured so that a single uniform fuel cartridge 412 and stackable fuel cell unit 410 allow the generator 400 to power low demand tools or appliances, such as a radio. When powering multiple or higher demand tools or appliances, exemplary embodiments of the generator 400 are configured with multiple stackable fuel cell units 410 and/or one or more internal batteries in order to meet power demands. In further embodiments, one or more inverters are included for standardizing the current. In additional embodiments, the electronics of the generator 400 are configured to control the power draw from the stackable fuel cell units 410. For example, the electronics are configured to equalize the power draw from individual stackable fuel cell units 410 and the like. The generator 400 may be further configured to allow a user to manually determine the power draw from each stackable fuel cell unit. In further embodiments, the housing 404 is configured with an inverter, if for example, the generator 400 is being used to power an AC motor of a coupled device.

Individual stackable fuel cell units 410 are configured to provide a uniform current when coupled with other stackable fuel cell units 410. Preferably, each stackable fuel cell unit 410 is a discrete fuel cell stack configured to provide a standard voltage and current, rather than the stackable fuel cell units 410 forming a single fuel cell stack for the entire generator 400. Configuring the generator 400 so as to allow for semi-customization allows the user to minimize the size of the generator, permits rapid stackable fuel cell unit changing, easy removal of defective units, and the like. In a further embodiment, the generator 400 includes one or more indicators, which provide information to a user regarding the various components of the generator.

It is believed that the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof. It is the intention of the following claims to encompass and include such changes.

What is claimed is:

1. A battery charger, comprising:
a carrying case housing for transporting a cordless tool, the carrying case housing including a handle member for transporting the housing;
a docking station at least partially contained by the housing, the docking station configured for physically and electrically coupling a removable battery; and,
a fuel cell system at least partially contained by and electrically coupled with the docking station,
wherein the fuel cell system produces electrical energy, the electrical energy being provided to the docking station for charging a removable battery coupled with the docking station.

2. A battery charger as claimed in claim 1, wherein the carrying case housing is a clamshell configuration, such that the carrying case housing includes an upper portion and a lower portion hingedly connected for establishing the housing in an open position and a closed position.

3. A battery charger as claimed in claim 1, wherein the carrying case housing is configured with a recess for storing a removable battery not undergoing recharging.

4. A battery charger as claimed in claim 1, wherein the carrying case housing is contoured for allowing the housing to be established in a closed position while a removable battery coupled with the docking station is being charged.

5. A battery charger as claimed in claim 1, wherein a visual indicator is included for providing information to a user regarding status of a battery being charged.

6. A workstation, comprising:
a support base;
a handle member coupled to the supporting base for transporting the workstation;
a worklight mounted to the handle member for illuminating a workspace;
a docking station at least partially contained by and disposed within an upper surface of the supporting base, the docking station configured for physically and electrically coupling a removable battery; and,
a fuel cell system being at least partially contained by the supporting base, the fuel cell system being electrically coupled with the docking station and the worklight,
wherein the fuel cell system produces electrical energy, the electrical energy being provided to the docking station for charging a removable battery coupled with the docking station and further being provided for illuminating the worklight.

7. A workstation, as claimed in claim 6, wherein the worklight is removably and rotatably attached to the handle member.

8. A workstation as claimed in claim 6, wherein the docking station includes generally opposed rails for physically accepting a removable battery.

9. A workstation as claimed in claim 6, wherein the worklight is configured to run off of a removable battery coupled with the docking station when the fuel cell system is not producing electrical energy.

10. A workstation as claimed in claim 6, wherein a visual indicator is included for providing information to a user regarding status of a battery being charged.

11. A compressor, comprising:
a housing;
a motor for operating the compressor, the motor being at least partially contained by the housing;
a storage tank for storing compressed gas, the storage tank being at least partially contained by the housing;
a pressure gauge disposed on an exterior surface of the housing;
a pressure regulator disposed on an exterior surface of the housing;
a carrying handle for transporting the compressor, the carrying handle coupled to the housing;
an internal battery, the internal battery being at least partially contained by the housing, the internal battery being electrically coupled with the motor; and
a fuel cell system being at least partially contained by the housing, the fuel cell system being electrically coupled with the internal battery,
wherein the fuel cell system provides electrical energy to the internal battery for utilization by the motor for operating the compressor.

12. A compressor as claimed in claim 11, wherein a visual indicator is included for providing information to a user regarding status of the fuel cell system.

13. A compressor as claimed in claim 11, further comprising an inverter for providing AC power.

14. A compressor as claimed in claim 11, wherein the compressor further includes a power cord for connecting with a standard power source outlet.

15. A compressor as claimed in claim 14, wherein the compressor further includes electronics configured, upon connection of the compressor to a standard power source outlet, to automatically operate the compressor from the standard power source.

16. A generator, comprising:
a support base;
an adjustably coupleable housing having a plurality of outlets for electrically coupling with corded devices;
a carrying handle coupled with the housing for transporting the generator; and,
a fuel cell system having at least one stackable fuel cell unit, the stackable fuel cell unit being electrically coupled with the housing, the stackable fuel cell unit being physically and removably configured between the housing and the support base, the stackable fuel cell unit being further configured for removably coupling with a corresponding uniform fuel cartridge,
wherein the base and the housing are configured to interact with a plurality of stackable fuel cell units for allowing the stackable fuel cell units to provide a standardized current for the generator for powering devices electrically coupled with the generator.

17. A generator as claimed in claim 16, further comprising a locking mechanism for use in securing a plurality of stackable fuel cell units between the support base and the housing.

18. A generator as claimed in claim 16, wherein the generator is further configured with electronics for automatically controlling the power draw from each stackable fuel cell unit included with the generator.

19. A generator, as claimed in claim 16, wherein a visual indicator is included for providing information to a user regarding status of the fuel cell system of the generator.

20. A generator, as claimed in claim 16, further comprising an inverter for allowing the housing of the generator to provide a standardized AC current.
